(19) United States
(12) Patent Application Publication
(10) Pub. No.: US 2006/0128448 A1
(43) Pub. Date: Jun. 15, 2006

(54) Mobile phone having an easy-receive feature for an incoming call

(76) Inventor: Meoung-Jin Lim, San Diego, CA (US)

Correspondence Address: L. Howard Chen;PRESTON GATES & ELLIS LLP, Suite 1700, 55 Second Street, San Francisco, CA, 94102-3493, US

(21) Appl. No.: 11/013,606

(22) Filed: Dec. 15, 2004

(51) Int. Cl. H04M 1/00

(52) U.S. Cl. 455/575.3; 455/550.1

(57) ABSTRACT

A mobile phone having an easy-receive feature for an incoming call includes a body and a receiver coupled to the body and configured to convey voice communication to a user. A microphone is coupled to the body and is configured to convey voice communication from the user. The body has an open position and a closed position. A loudspeaker is coupled to the body. A means for activating the easy-receive feature is coupled to the body and upon activation the mobile phone is configured to answer the incoming call by routing voice communication to the loudspeaker if the body is in the closed position. Otherwise the mobile phone is configured to route voice communication to the receiver if the body is in the open position.

### FIELD OF THE INVENTION

The present invention relates to mobile phones, and more particularly to a mobile phone having an easy-receive feature for an incoming call.

### BACKGROUND OF THE INVENTION

FIG. 1 is a diagram of the front side of conventional mobile phone 10 while closed. Body 12 has loudspeaker 14, antennae 16 and volume control buttons 18. Mobile phone 10 is a flip-top or clamshell design. During an incoming, or mobile-terminated (MT) call, loudspeaker 14 emits a tone to alert a user to the call.

FIG. 2 is a diagram of the left side of conventional mobile phone 10 from FIG. 1 while closed. FIG. 2 further illustrates upper body 12a and lower body 12b. Reference numeral 12 refers to the upper body 12a and lower body 12b together, as opposed to reference numeral 12a to the upper body and 12b to the lower body separately. Upper body 12a, in a flip-top design, is mounted to lower body 12b with a hinge (see FIG. 4) that swings upper body 12a through approximately 150 degrees, in order to open mobile phone 10 (also see FIG. 4).

FIG. 3 is a diagram of the right side of conventional mobile phone 10 from FIG. 1 while closed, illustrating antennae 16 mounted to lower body 12b, and upper body 12a.

FIG. 4 is a diagram of the front of conventional mobile phone 10 from FIG. 1 while open. In order to answer a MT call, a user opens mobile phone 10, resulting in a front view with upper body 12a connected to lower body 12b with hinge 20. Upper body 12a includes screen 22 and receiver 24. Screen 22 may display the number or identity of the incoming call, if known, as well as features such as signal strength, battery level, roaming or in-network, and so forth. The user will place mobile phone 10 against their head in order to position receiver 24 against the ear in order to hear incoming sound.

Lower body 12b includes volume control buttons 18, end button 26, send button 28, dial keys 30, and microphone 32. The user answers the incoming call by pressing the send button 28, then initiates conversation by placing mobile phone 10 against their head so they may hear from receiver 24 and speak into microphone 32.

One problem with conventional mobile phone 10 is that three steps are needed in order to initiate a conversation: 1) Open the phone; 2) Press a button to accept the call; and 3) Place the phone in a position to hear from the receiver and speak into the microphone.

Accordingly, what is needed is a mobile phone having an easy-receive feature for an incoming call. The present invention addresses such a need.

### BRIEF SUMMARY OF THE INVENTION

The present invention provides a mobile phone having an easy-receive feature for an incoming call. One embodiment of the invention includes a body and a receiver coupled to the body and configured to convey voice communication to a user. A microphone is coupled to the body and is configured to convey voice communication from the user. The body has an open position and a closed position. A loudspeaker is coupled to the body. A means for activating the easy-receive feature is coupled to the body and upon activation the mobile phone is configured to answer the incoming call by routing voice communication to the loudspeaker if the body is in the closed position. Otherwise the mobile phone is configured to route voice communication to the receiver if the body is in the open position.

According to a method and system disclosed herein, the present invention provides a user with a feature whereby they may answer the phone by skipping the steps of opening the phone and placing it next to their head. By pressing an exposed button on the closed phone, they answer the phone with voice communication from the caller directed to the loudspeaker rather than the receiver. The increased volume of the loudspeaker permits communication without having to place the mobile phone against the user's ear. Also, the microphone may be positioned so as to receive sound from the user without opening the phone.

### BRIEF DESCRIPTION OF SEVERAL VIEWS OF THE DRAWINGS

FIG. 1 is a diagram of the front side of a conventional mobile phone while closed.

FIG. 2 is a diagram of the left side of the conventional mobile phone of FIG. 1 while closed.

FIG. 3 is a diagram of the right side of the conventional mobile phone of FIG. 1 while closed.

FIG. 4 is a diagram of the front of the conventional mobile phone of FIG. 1 while open.

FIG. 5 is a diagram of the front side of a mobile phone while closed, illustrating one embodiment of the invention.

FIG. 6 is a diagram of the left side of the mobile phone of FIG. 1 while closed, illustrating one embodiment of the invention.

FIG. 7 is a diagram of the right side of the mobile phone of FIG. 1 while closed, illustrating one embodiment of the invention.

FIG. 8 is a diagram of the front of the mobile phone of FIG. 1 while open, illustrating one embodiment of the invention.

FIG. 9 is a flow diagram illustrating one method of receiving a call at a mobile phone.

FIG. 10 is a flow diagram illustrating another method of receiving a call at a mobile phone.

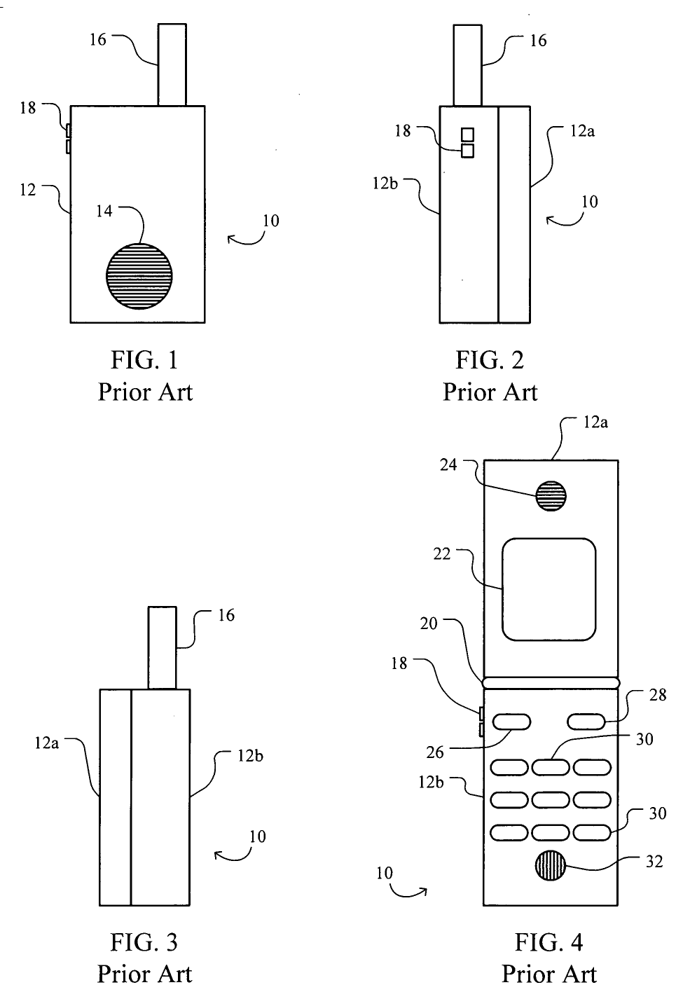

### DETAILED DESCRIPTION OF THE INVENTION

The present invention relates to mobile phones, and more particularly to a mobile phone having an easy-receive feature for an incoming call. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

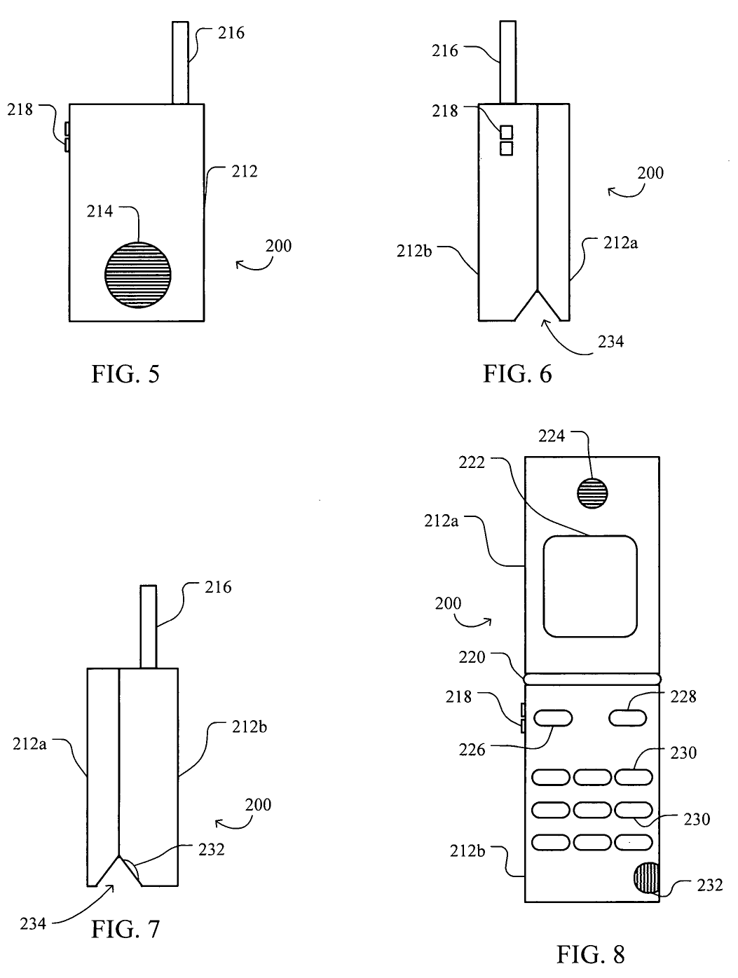

FIG. 5 is a diagram illustrating one embodiment of the invention of the front side of mobile phone 200 while closed. Body 212 has loudspeaker 214, antennae 216 and buttons 218, for example volume control. Loudspeaker 214 typically uses an audio band sampling frequency, which is typically up to 48 KHz for a ringing tone that announces an incoming call (mobile terminated (MT)). Mobile phone 200 is illustrated as a flip-top or clamshell design. One skilled in the art will recognize that the invention applies to any mobile phone, but in particular to those needing some physical manipulation other than pressing a button and placing the phone near ones head in order to answer a call. Examples of physical manipulation include phones with slide and swivel tops.

FIG. 6 is a diagram illustrating one embodiment of the invention of the left side of mobile phone 200 from FIG. 5 while closed. FIG. 6 illustrates upper body 212a and lower body 212b. Reference numeral 212 refers to the upper body 212a and lower body 212b together, as opposed to reference numeral 212a to the upper body and 212b to the lower body separately. Upper body 212a, in a flip-top design, is mounted to lower body 212b with a hinge (see FIG. 8) that swings upper body 212a through an arc in order to open mobile phone 200.

Audio channel 234 between upper body 212a and lower body 212b provides a path for sound to reach microphone 232 (see FIG. 7).

FIG. 7 is a diagram illustrating one embodiment of the invention of the right side of mobile phone 200 from FIG. 5 while closed, illustrating antennae 216 mounted to lower body 212b, and upper body 212a. Audio channel 234 provides a space for sound to reach microphone 232, in contrast to conventional mobile phones (see FIG. 3).

In another embodiment of the invention and illustrated in FIG. 7, microphone 232 extends to the side of lower body 212b. Although illustrated on the right side of mobile phone 200, either side is adequate. Additionally, audio channel 234 may be optional if microphone 232 is positioned on the bottom or sides of lower body 212b.

In another embodiment, microphone 232 may project downward or outward (not shown) from body 212a.

FIG. 8 is a diagram illustrating one embodiment of the invention of the front of mobile phone 200 from FIG. 5 while open. Upper body 212a is connected to lower body 212b with hinge 220. Upper body 212a includes screen 222 and receiver 224. Screen 222 may display the number or identity of the incoming call, if known, as well as features such as signal strength, battery level, roaming or in-network, and so forth.

Lower body 212b includes control buttons 218, end-call button 226, call-answer button 228, dial keys 230, and microphone 232. Microphone 232 may cover more than a single surface of lower body 212b, it may be located on the bottom of lower body 212b (not shown), or there may be multiple microphones (not shown). Audio channel 234 from FIG. 6 and FIG. 7 may or may not be included, depending on the position and sensitivity of microphone 232.

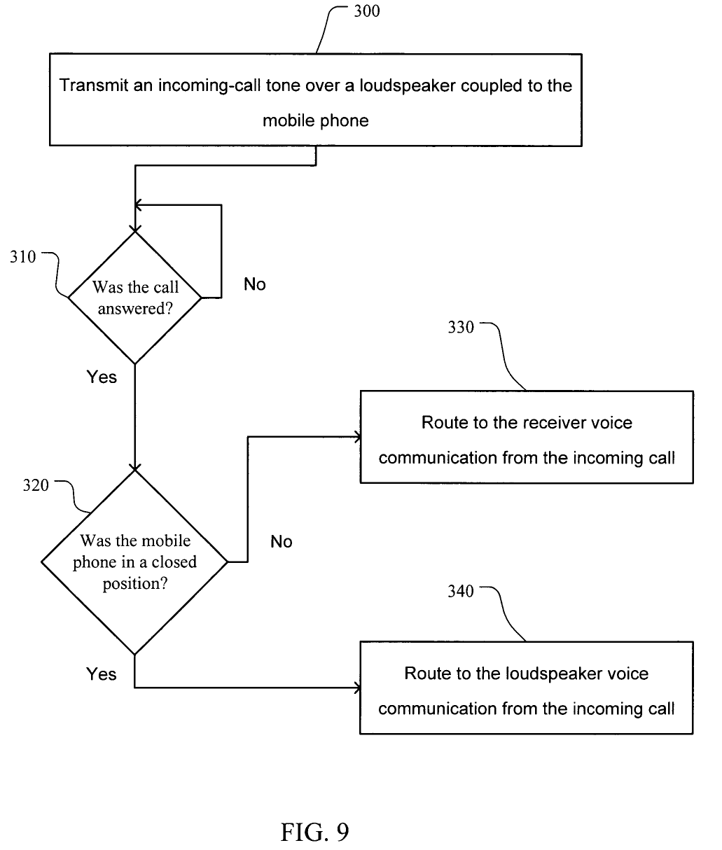

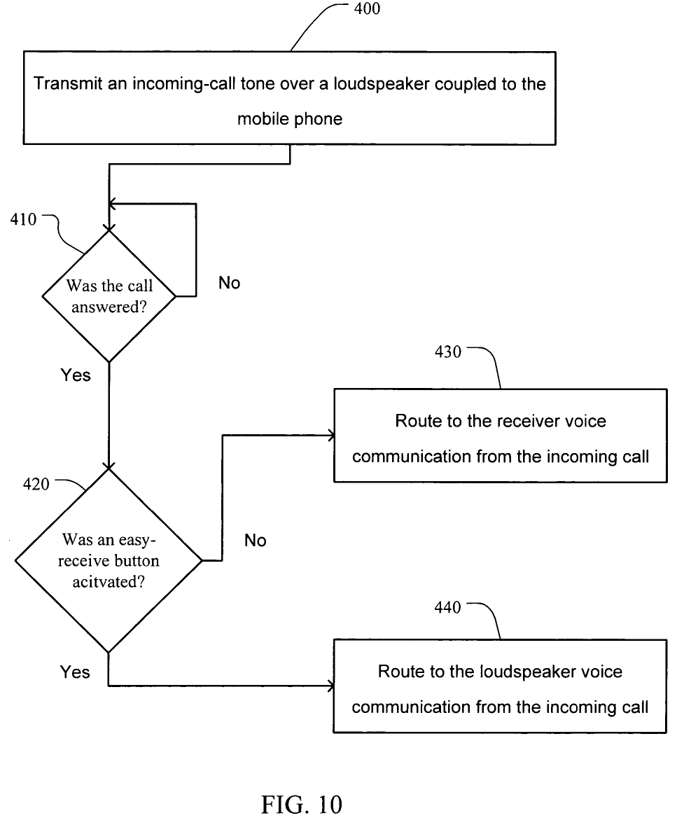

FIG. 9 is a flow diagram illustrating one method of receiving a call at a mobile phone. FIG. 9 will be discussed in conjunction with FIG. 5, FIG. 7 and FIG. 8 for illustrative purposes, though the method in FIG. 9 is not limited to the previously disclosed embodiments. Assume that mobile phone 200 receives a call from a caller. As a result, in block 300, mobile phone 200 transmits an incoming-call tone over loudspeaker 214 to the user. Other means of alerting the user are available, for example, through vibrating and lighting, but not limited to those.

In block 310, mobile phone 200 determines if the call is answered by the user. If the call is not answered, mobile phone 200 may continue ringing, the carrier may eventually terminate the call or direct it to voicemail or another number.

If the call is answered in block 310, then in block 320 mobile phone 200 determines if it is in a closed position, as illustrated by the embodiments disclosed in FIG. 5, FIG. 6, and FIG. 7. Alternatively, mobile phone 200 could determine if it is in an open position. In either case, a switch or a sensor (not shown) may be connected to hinge 220 to provide that information.

Mobile phone 200 may be answered in a closed position by activating (pressing) any button configured as an easy-receive button. Any exterior button may be used, for example either one of volume control buttons 218. The button used may be accessed while mobile phone 200 is in a closed position.

If mobile phone 200 is in the open position when answered in block 310 (or not in the closed position), then in block 330 mobile phone 200 routes voice communication from the incoming call to receiver 224. In the open position, mobile phone 200 may be answered by any button configured as a call-answering button, for example call-answer button 228.

If mobile phone 200 is in the closed position when answered in block 310, then in block 340 mobile phone 200 routes voice communication from the incoming call to loudspeaker 214.

Loudspeaker 214 typically uses an audio band sampling frequency, which may be higher than the voice band sampling frequency that is used in voice communication in the call. In the case that the sampling rates of loudspeaker 214 and receiver 224 differ, voice communication to loudspeaker 214 may be up-sampled.

Because loudspeaker 214 and microphone 232 are in close proximity relative to receiver 224 and microphone 232 (while mobile phone 200 is in the open position), and loudspeaker 214 operates at a greater volume than receiver 224, echo cancellation enhancement may be activated in one embodiment of the invention. In another embodiment of the invention, microphone 232 may be muted while loudspeaker 214 is projecting voice communication, and active during pauses from the caller. By projecting voice communication from the caller, through loudspeaker 214 at a high volume, and positioning microphone 232 to receive voice communication from the user, mobile phone 200 provides an easy-receive feature that eliminates two steps in conventional mobile phones. The user does not have to open mobile phone 200 and does not have to place mobile phone 200 up to their head in order to communicate. The increased volume from loudspeaker 214 may be sufficient for the user to hear voice communication from the caller, and microphone 232 is positioned, perhaps within audio channel 234, in order to receive voice communication from the user. Typically the distance between a user's mouth and microphone 232 is increased during use of the easy-receive feature than in normal receive mode, so a higher sensitivity in microphone 232 may be needed. Other enhancements, such as echo cancellation enhancement or muting, may be applied to further communication.

FIG. 10 is a flow diagram illustrating another method of receiving a call at a mobile phone. FIG. 10 will be discussed in conjunction with FIG. 5, FIG. 7 and FIG. 8 for illustrative purposes, though the method in FIG. 10 is not limited to the previously disclosed embodiments. Assume that mobile phone 200 receives a call from a caller. As a result, in block 400, mobile phone 200 transmits an incoming-call tone over loudspeaker 214 to the user. Other means of alerting the user are available, for example, through vibrating and lighting, but not limited to those.

In block 410, mobile phone 200 determines if the call is answered by the user. If the call is not answered, mobile phone 200 may continue ringing, the carrier may eventually terminate the call or direct it to voicemail or another number.

If the call is answered in block 410, then in block 420 mobile phone 200 determines if an easy-receive button was activated. An easy-receive button may be dedicated to the easy-receive feature or it may have multiple uses depending on the situation. For example, buttons 218 may perform an easy-receive function while mobile phone 200 is receiving a not-yet-answered call, and may perform volume control during a conversation (after accepting the received call). Other buttons or means of activating an easy-receive feature may be implemented, for example voice commands, a slide, a switch, an automatic easy-receive mode, a dial, and so on. In another embodiment, mobile phone 200 may determine if a call-answer button was activated rather than an easy-receive button.

If the call is not answered with an easy-receive button, then the call is answered by any button configured as a call-answering button, for example call-answer button 228.

If the call is not answered in block 420 with an easy-receive button, then in block 430 mobile phone 200 routes voice communication from the caller to receiver 224.

If the call is answered in block 420 with an easy-receive button, then in block 440 mobile phone 200 routes voice communication from the caller to loudspeaker 214.

According to the method and system disclosed herein, the present invention provides an easy-receive feature for an incoming call on a mobile phone. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We Claim:

1. A mobile phone having an easy-receive feature for an incoming call comprising:
a body;
a receiver coupled to the body and configured to convey voice communication to a user,
a microphone coupled to the body and configured to convey voice communication from the user, the body having an open position with the proximity of the receiver and microphone generally accessible to the user, and a closed position with the proximity of the receiver and microphone generally inaccessible to the user relative to the open position;
a loudspeaker coupled to the body; and
a means for activating the easy-receive feature coupled to the body and upon activation, the mobile phone is configured to answer the incoming call by routing voice communication to the loudspeaker if the body is in the closed position, otherwise the mobile phone is configured to route voice communication to the receiver if the body is in the open position.

2. The mobile phone of claim 1 wherein the microphone is positioned to convey voice communication from the user in the open position and in the closed position.

3. The mobile phone of claim 2 wherein the microphone is located in an audio channel.

4. The mobile phone of claim 1 further comprising:
a call-answering button coupled to the body, the mobile phone configured to answer an incoming call by routing voice communication to the receiver upon activation of the call-answering button.

5. The mobile phone of claim 1, the means for activating the easy-receive feature comprising:
a button coupled to the body.

6. A mobile phone having an easy-receive feature comprising:
a body;
a receiver coupled to the body and configured to convey voice communication to a user;
a loudspeaker coupled to the body;
a call-answering button coupled to the body, the mobile phone configured to answer an incoming call by routing voice communication to the receiver upon activation of the call-answering button; and
an easy-receive button coupled to the body, the mobile phone configured to answer the incoming call by routing voice communication to the loudspeaker upon activation of the easy-receive button.

7. The mobile phone of claim 6 further comprising:
a microphone coupled to the body and positioned to convey voice communication from the user during routing of voice communication to either the loudspeaker or the receiver.

8. The mobile phone of claim 7 wherein the microphone is located in an audio channel.

9. A mobile phone having an easy-receive feature comprising:
an upper body comprising:
a receiver coupled to the upper body and configured to convey voice communication to a user;
a loudspeaker coupled to the upper body; and
a lower body movably coupled to the upper body, the mobile phone having a closed position with the lower body proximate to the upper body and an open position with the lower body removed away from and adjacent to the upper body, the lower body comprising:
a means for activating the easy-receive feature coupled to the lower body and available to the user in the closed position, the mobile phone configured to route voice communication to the loudspeaker if the means for activating the easy-receive feature was activated with the mobile phone in the closed position.

10. The mobile phone of claim 9 further comprising:
a microphone coupled to the lower body and positioned to receive voice communication from the user in the open position and in the closed position.

11. The mobile phone of claim 10 wherein the microphone is located in an audio channel.

12. The mobile phone of claim 10 further comprising:
a call-answering button coupled to the lower body and accessible to the user in the open position and inaccessible to the user in the closed position, the mobile phone configured to answer the incoming call by routing voice communication to the receiver if the call-answering button is activated.

13. The mobile phone of claim 9, the means for activating the easy-receive feature comprising:
a button coupled to the body.

14. A computer-readable medium containing programming instructions for receiving an incoming call at a mobile phone, the programming instructions comprising:
transmitting an incoming-call tone to an alerting means coupled to the mobile phone;
determining whether a call-answering button coupled to the mobile phone was activated or whether an easy-receive button coupled to the mobile phone was activated;
routing to a receiver coupled to the mobile phone, if the call-answering button was activated, voice communication from the incoming call; and
routing to a loudspeaker, if the easy-receive button was activated, voice communication from the incoming call.

15. The computer-readable medium of claim 14, the programming instructions further comprising:
routing to the receiver, if the call-answering button was activated after the easy-receive button was activated, voice communication from the incoming call.

16. The computer-readable medium of claim 14, the programming instructions further comprising:
routing to the loudspeaker, if the easy-receive button was activated after the call-answering button was activated, voice communication from the incoming call.

17. The computer-readable medium of claim 14, the programming instructions further comprising:
determining whether the mobile phone was in an open position or a closed position;
routing to the receiver, if the mobile phone was in the open position, voice communication from the incoming call; and
routing to the loudspeaker, if the mobile phone was in the closed position, voice communication from the incoming call.

18. The computer-readable medium of claim 14, the programming instructions further comprising:
activating echo cancellation enhancement if voice communication is routed to the loudspeaker.

19. The computer-readable medium of claim 18, activating echo cancellation enhancement further comprising:
muting a microphone coupled to the mobile phone while voice communication is issuing from the loudspeaker.

20. The computer-readable medium of claim 14, wherein the alerting means is the loudspeaker.
